(19) United States
(12) Patent Application Publication
(10) Pub. No.: US 2026/0368747 A1
(43) Pub. Date: Nov. 19, 2026

(54) Optimized Knowledge-Based Staff Deployment in Commerce Related Service Industries

(71) Applicant: International Business Machines Corporation, Armonk, NY (US)

(72) Inventors: Jeremy R FOX, Georgetown, TX (US); Martin G. KEEN, Cary, NC (US); Alexander REZNICEK, Troy, NY (US); Bahman HEKMATSHOARTABARI, White Plains, NY (US)

(21) Appl. No.: 18/747,588

(22) Filed: Jun. 19, 2024

(51) Int. Cl. G06Q 30/015; G06Q 10/0631; H04W 4/02

(52) U.S. Cl. CPC G06Q 30/015; G06Q 10/063112; G06Q 10/063116; H04W 4/023

(57) ABSTRACT

A computer-implemented method for matching a customer with a staff member based on the customer query and a staff member experience and proximity. The method receives a customer query from a customer located within a physical retail space and classifies the customer query into one or more predefined categories. The method compares information in the customer query with a staff profile database of the one or more staff members and ranks the one or more staff members to assist the customer based on the comparison. The method directs the highest-ranking staff member to assist the customer.

### BACKGROUND

The present disclosure relates generally to the field of natural language processing (NLP) and more particularly to real-time interactive matching of a customer with knowledgeable staff in a retail or service environment.

In the retail and service industries, the ability to quickly connect customers with the most knowledgeable staff member in a specific area of expertise is crucial for customer satisfaction and efficient service delivery. This challenge becomes more pronounced in larger retail spaces or businesses where staff specialization varies, and customer needs are diverse. The success of this process significantly impacts customer experience, staff utilization, and overall business performance.

Customers often face delays and frustration when seeking assistance, leading to a diminished shopping experience and potential loss of sales for the business.

Currently, there is no efficient system to quickly identify and dispatch the most suitable employee to assist a customer in need of assistance.

### BRIEF SUMMARY

Embodiments of the present invention disclose a method, a computer program product, and a system, for efficiently matching a customer with a staff member in a retail and service environment.

According to an embodiment, the method receives a customer query from a customer located within a physical retail space and classifies the customer query into one or more predefined categories. The method further compares information in the customer query with a staff profile database of the one or more staff members and ranks the one or more staff members to assist the customer based on the comparison. The method further directs a highest-ranking staff member to assist the customer.

A computer program product, according to an embodiment of the invention, comprising one or more computer-readable storage media and program instructions stored on the one or more storage media to perform operations comprising the following method steps. The method receives a customer query from a customer located within a physical retail space and classifies the customer query into one or more predefined categories. The method further compares information in the customer query with a staff profile database of the one or more staff members and ranks the one or more staff members to assist the customer based on the comparison. The method further directs a highest-ranking staff member to assist the customer.

A computer system, according to an embodiment of the invention, includes a processor set, one or more computer-readable storage media, and program instructions stored on the one or more storage media to cause the processor set to perform operations. The program instructions implement a method. The method receives a customer query from a customer located within a physical retail space and classifies the customer query into one or more predefined categories. The method further compares information in the customer query with a staff profile database of the one or more staff members and ranks the one or more staff members to assist the customer based on the comparison. The method further directs a highest-ranking staff member to assist the customer.

### BRIEF DESCRIPTION OF THE DRAWINGS

FIG. 1 depicts a diagram graphically illustrating the hardware components of a computing environment 100, such as adaptive query-staff matching computing environment 200, and a cloud computing environment, in accordance with an embodiment of the present invention.

FIG. 2 illustrates adaptive query-staff matching computing environment 200, in accordance with an embodiment of the present invention.

FIG. 3 is a flowchart illustrating the operation of adaptive query-staff matching program 220 of FIG. 2, in accordance with an embodiment of the present invention.

### DETAILED DESCRIPTION

The present invention addresses the challenge of efficiently connecting customers with the most knowledgeable staff member, in real-time, within retail and service environments, utilizing advanced technologies to enhance customer experience and optimize staff resource allocation.

Staff members often have varied expertise and availability, making it challenging to identify who is best suited to address a specific customer query at any given time.

Without a system to quickly identify and dispatch the most suitable employee, staff members may be unevenly burdened, leading to inefficiencies and reduced overall productivity.

On the other hand, customers expect prompt and accurate assistance. Delays or misdirection in finding the right staff member can lead to customer dissatisfaction and lost business opportunities.

In industries where customer queries are complex and diverse (e.g., electronics, home improvement, high-end retail, etc.), the inability to swiftly match customer needs with the right expertise hinders service quality and business performance.

Many businesses struggle to effectively integrate technology to streamline the process of connecting customers with the appropriate staff member, often relying on outdated or inefficient methods.

The novelty of the present invention includes the following features: integrated real-time location tracking; dynamic staff profiling algorithm, advanced NLP for customer queries; seamless interaction between components; and an adaptive query-staff matching mechanism.

Hereinafter, exemplary embodiments of the present invention will be described in detail with reference to the attached drawings.

The present invention is not limited to the exemplary embodiments below but may be implemented with various modifications within the scope of the present invention. In addition, the drawings used herein are for purposes of illustration, and may not show actual dimensions.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

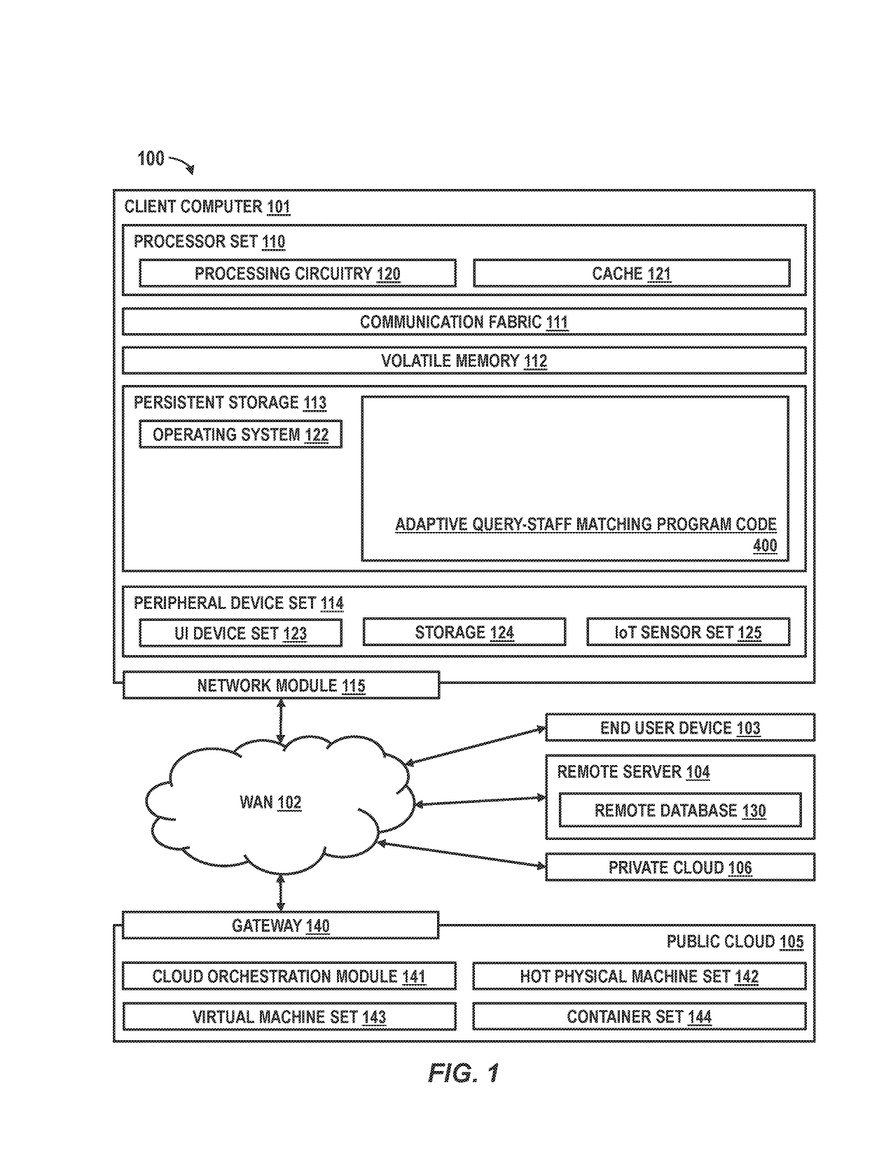

FIG. 1 depicts a diagram graphically illustrating the hardware components of adaptive query-staff matching computing environment 200 and a cloud computing environment in accordance with an embodiment of the present invention.

Adaptive query-staff matching computing environment 200 contains an example of an environment for the execution of at least some of the computer code involved in performing the inventive methods, such as adaptive query-staff matching program code 400. In addition to adaptive query-staff matching program code 400, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and adaptive query-staff matching program code 400, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in adaptive query-staff matching program code 400 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open-source Portable Operating System Interface type operating systems that employ a kernel. The code included in adaptive query-staff matching program code 400 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

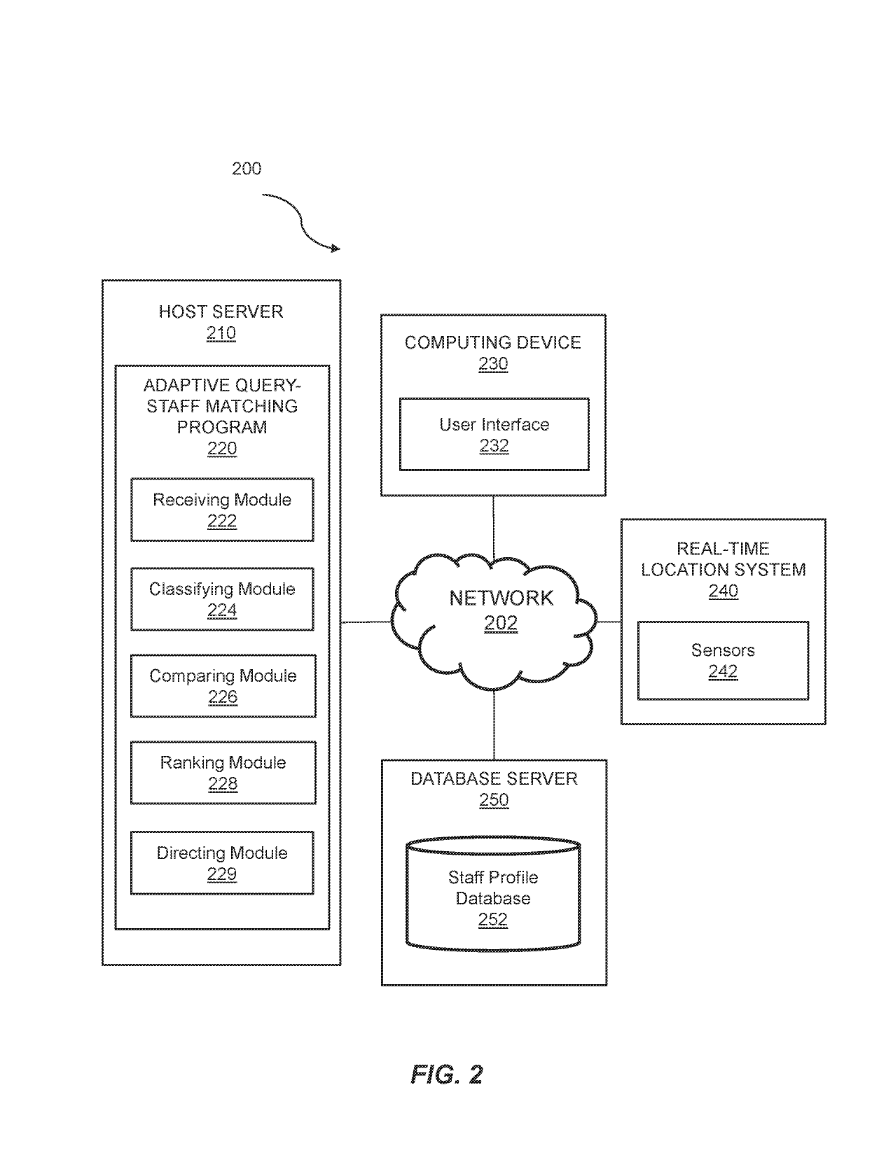

FIG. 2 illustrates adaptive query-staff matching computing environment 200, in accordance with an embodiment of the present invention. Adaptive query-staff matching computing environment 200 includes host server 210, computing device 230, real-time location system (RTLS) 240, and database server 250 all connected via network 202. The setup in FIG. 2 represents an example embodiment configuration for the present invention and is not limited to the depicted setup to derive benefit from the present invention.

In an exemplary embodiment, host server 210 includes adaptive query-staff matching program 220. In various embodiments, host server 210 may be a laptop computer, tablet computer, netbook computer, personal computer (PC), a desktop computer, a personal digital assistant (PDA), a smart phone, or any programmable electronic device capable of communicating with computing device 230, RTLS 240, and database server 250 via network 202. Host server 210 may include internal and external hardware components, as depicted, and described in further detail with reference to FIG. 1. In other embodiments, host server 210 may be implemented in a cloud computing environment, as further described in relation to FIG. 1 herein. Host server 210 may also have wireless connectivity capabilities allowing it to communicate with computing device 230, RTLS 240, database server 250, and other computers or servers over network 202.

With continued reference to FIG. 2, computing device 230 includes user interface 232 and may be a laptop computer, tablet computer, netbook computer, personal computer (PC), a desktop computer, a personal digital assistant (PDA), a smart phone, or any programmable electronic device capable of communicating with host server 210, RTLS 240, and database server 250 via network 202. Computing device 230 may include internal and external hardware components, as depicted, and described in further detail below with reference to FIG. 1. In other embodiments, computing device 230 may be implemented in a cloud computing environment, as described in relation to FIG. 1, herein.

In exemplary embodiments, user interface 232 is a computer program which allows a user (e.g., customer or staff member) to interact with computing device 230 and other connected devices via network 202. For example, user interface 232 may be a graphical user interface (GUI). In addition to comprising a computer program, user interface 232 may be connectively coupled to hardware components, such as those depicted in FIG. 1, for receiving user input. However, in other embodiments user interface 232 may be a different program capable of receiving user interaction and communicating with other devices.

In exemplary embodiments, user interface 232 may include a user communication interface (e.g., a chatbot, a smart speaker, voice commands, digital interface, keyboard, etc.) that permits a user to submit a query, or question, about a particular category of help or assistance they need in a physical retail store or business environment. This invention is not limited to physical retail store or business environments but may be utilized in any setting or space that may benefit from a user query/response mechanism.

With continued reference to FIG. 2, RTLS 240 comprises sensors 242 that provide necessary infrastructure for indoor positioning, such as hardware transmitter beacons that broadcast their identifier to nearby portable electronic devices (e.g., computing device 230) and wireless fidelity (Wi-Fi) access points throughout the retail or service environment capable of communicating with host server 210, computing device 230, and database server 250 via network 202.

In exemplary embodiments, RTLS 240 is designed to interface with mobile and wearable devices (e.g., computing device 230) carried by staff members and customers alike. RTLS 240 uses device signals to determine their positions within the retail or service environment. This integration is used for tracking movements and locations in real-time.

In exemplary embodiments, RTLS 240 complies with privacy standards such as general data protection regulation (GDPR) to protect user location data and ensuring ethical and legal use of the technology.

In exemplary embodiments, RTLS 240 includes one or more sensors 242. Sensors 242 may be a device, hardware component, module, or subsystem capable of recording, capturing, and detecting locations, proximity, events, and/or changes in RTLS 240 and sending the detected data to other electronics (e.g., host server 210), components (e.g., staff profile database 252), or programs (e.g., adaptive query-staff matching program 220) within a system (e.g., adaptive query-staff matching computing environment 200). In various embodiments, the detected data collected by sensors 242 is instrumental in providing feedback to adaptive query-staff matching program 220.

Sensors 242, in exemplary embodiments, may be located within RTLS 240 and may be a software application, proximity sensor, camera, microphone, light sensor, infrared sensor, weight sensor, magnetic ring sensor, temperature sensor, barometric pressure sensor, tactile sensor, motion detector, optical character recognition (OCR) sensor, occupancy sensor, heat sensor, analog sensor, radar, radio frequency sensor, quick response (QR) code, video camera, digital camera, Internet of Things (IoT) sensors, lasers, gyroscopes, accelerometers, actuators, structured light systems, tracking sensors, hardware transmitter beacons, and other devices used for measuring, detecting, tracking, and/or recording a physical retail space or business environment within adaptive query-staff matching computing environment 200.

In exemplary embodiments, sensors 242 are capable of continuously monitoring, collecting, and saving collected data on a local storage or storage on a separate server (e.g., staff profile database 252), or alternatively sending the collected data, or various selected pieces of the collected data, to adaptive query-staff matching program 220.

In alternative embodiments, sensors 242 may be capable of detecting, communicating, pairing, or syncing with internet of things (IoT) devices, thus creating opportunities for more direct integration of the physical world into computer-based systems, and resulting in improved efficiency, accuracy, and economic benefit in addition to reduced human intervention.

In exemplary embodiments, RTLS 240 collects signal data from various sources (e.g., hardware transmitter beacons, Wi-Fi, sensors 242) and processes this data to calculate and track precise positions of both the one or more staff members and customers within the retail store or business environment. Techniques like trilateration, signal strength analysis, and machine learning algorithms for pattern recognition are used for accurate position determination which is needed for aligning physical proximity in the matching process.

In exemplary embodiments, RTLS 240 implements indoor positioning technologies (e.g., sensors 242) to track movement and location of both the customer and the one or more staff members in real-time, analyzes a proximity of the customer and the one or more staff members, and identifies when the customer query matches a nearby staff member’s expertise. RTLS 240 interacts with adaptive query-staff matching program 220 to consider location in query prioritization.

Furthermore, RTLS 240 facilitates a swift physical connection by triggering an alert, or notification, to notify both the customer and the one or more staff members.

In further exemplary embodiments, RTLS 240 incorporates feedback from interactions to optimize location tracking accuracy and responsiveness. RTLS 240 uses this data to refine signal processing algorithms and improves the system’s overall performance.

In an exemplary embodiment, database server 250 includes staff profile database 252. In various embodiments, database server 250 may be a laptop computer, tablet computer, netbook computer, personal computer (PC), a desktop computer, a personal digital assistant (PDA), a smart phone, a server, or any programmable electronic device capable of communicating with host server 210, computing device 230, and RTLS 240, via network 202. Database server 250 may include internal and external hardware components, as depicted, and described in further detail with reference to FIG. 1. In other embodiments, database server 250 may be implemented in a cloud computing environment, as described in relation to FIG. 1, herein. Database server 250 may also have wireless connectivity capabilities allowing the database server 250 to communicate with host server 210, computing device 230, RTLS 240, and other computers or servers over network 202.

With continued reference to FIG. 2, database server 250 comprises staff profile database 252 and may be a laptop computer, tablet computer, netbook computer, personal computer (PC), a desktop computer, a personal digital assistant (PDA), a smart phone, or any programmable electronic device capable of communicating with host server 210, computing device 230, and RTLS 240, via network 202.

In exemplary embodiments, adaptive query-staff matching program 220 includes a staff profiling system (SPS) that gathers comprehensive data to create staff profiles comprising expertise areas, professional qualifications, professional experience, historical performance metrics, language skills, and current availability. Data collection is automated where possible and uses manual input for unique attributes. The created staff profiles are stored in staff profile database 252.

Adaptive query-staff matching program 220 uses various implementation techniques to create comprehensive staff profiles. One such implementation technique utilizes clustering algorithms (like K-means) and decision trees to analyze and rank expertise. Another implementation uses application programming interfaces (APIs) for integration with human resource (HR) systems, scheduling tools, and time-tracking software. Another implementation includes real-time data processing techniques to handle streaming data.

In exemplary embodiments, data collection used for staff profile creation adheres to the highest standards of information security management, ensuring the confidentiality of staff information.

In exemplary embodiments, adaptive query-staff matching program 220 continuously updates, in real-time, the information in the staff profiles database 252, comprising historical performance metrics, real-time availability, and updates based on staff interactions with customers and availability changes.

In exemplary embodiments, SPS provides adaptive query-staff matching program 220 with up-to-date staff information for optimal staff-customer pairing.

In alternative embodiments, SPS receives input from adaptive query-staff matching program 220 to refine staff profile accuracy.

With continued reference to FIG. 2, host server 210 includes adaptive query-staff matching program 220. Host server 210 may be a laptop computer, tablet computer, netbook computer, personal computer (PC), a desktop computer, a personal digital assistant (PDA), a smart phone, or any programmable electronic device capable of communicating with computing device 230, RTLS 240, and database server 250 via network 202.

With continued reference to FIG. 2, adaptive query-staff matching program 220, in an exemplary embodiment, may be a computer application on host server 210 that contains instruction sets, executable by a processor. The instruction sets may be described using a set of functional modules. In exemplary embodiments, adaptive query-staff matching program 220 may receive input from computing device 230, RTLS 240, and database server 250 over network 202. In alternative embodiments, adaptive query-staff matching program 220 may be a computer application on computing device 230, or a standalone program on a separate electronic device.

With continued reference to FIG. 2, the functional modules of adaptive query-staff matching program 220 include receiving module 222, classifying module 224, comparing module 226, ranking module 228, and directing module 229.

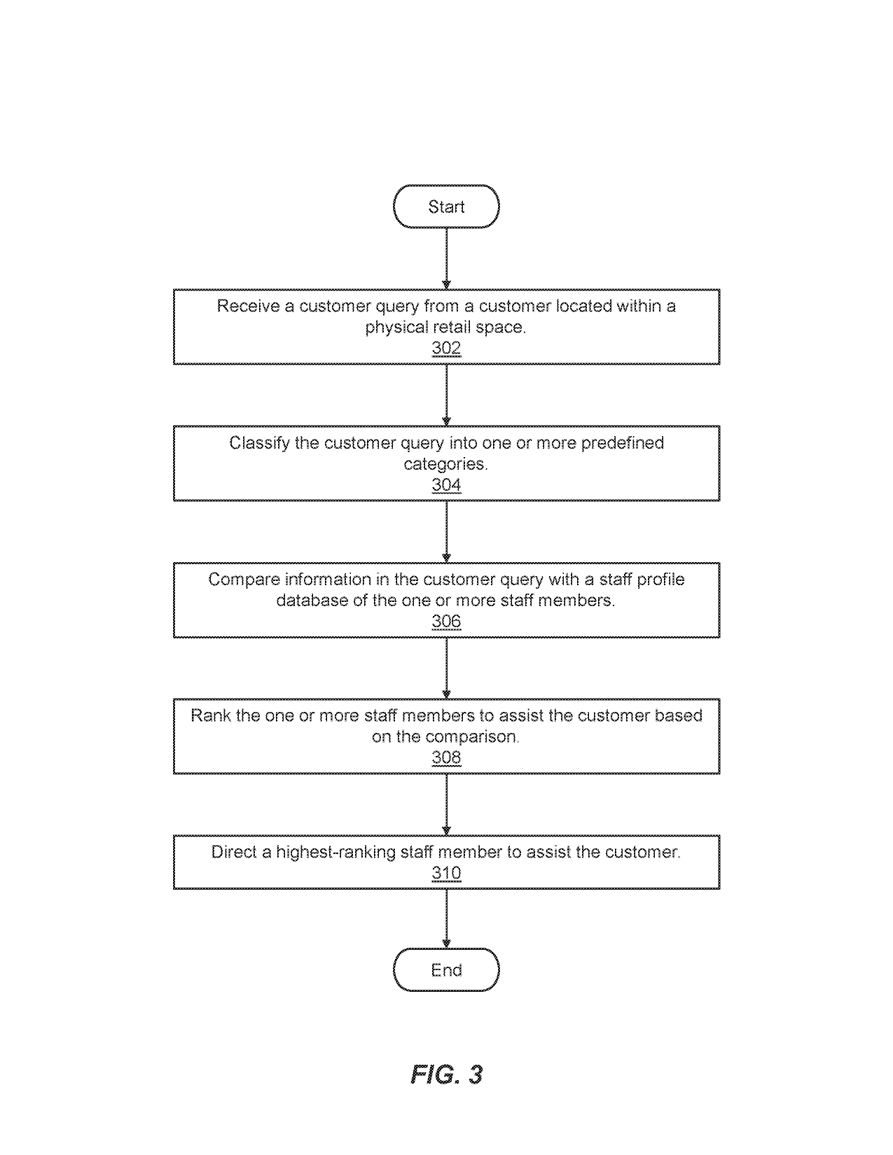

FIG. 3 is a flowchart illustrating the operation of adaptive query-staff matching program 220 of FIG. 2, in accordance with embodiments of the present disclosure.

With reference to FIGS. 2-3, receiving module 222 includes a set of programming instructions, in adaptive query-staff matching program 220, to receive a customer query from a customer located within a physical retail space (step 302). The set of programming instructions is executable by a processor.

In exemplary embodiments, receiving module 222 receives customer queries through various digital interfaces (e.g., user interface 232) including kiosks, mobile applications, and voice-recognition devices. Receiving module 222 pre-processes the customer query which involves cleansing the data, normalizing language inputs, and handling different languages or dialects. This step is crucial for preparing the customer query data for effective NLP analysis.

In exemplary embodiments, receiving module 222 utilizes APIs for seamless integration with various input interfaces (e.g., RESTful APIs for mobile application integration).

In exemplary embodiments, receiving module 222 uses natural language understanding (NLU) to decipher the semantics and intent of the customer query. Techniques such as tokenization, part-of-speech tagging, and dependency parsing are used for deep learning based NLU to understand the query’s structure and meaning. This step ensures that the adaptive query-staff matching program 220 grasps the customer’s request in depth.

With reference to an illustrative example, Customer A is a first-time homeowner who visits a large home improvement store looking for specific plumbing supplies to fix a leak but is unsure about the exact tools and parts needed. Customer A types into the store application on a mobile device, “I need immediate help, there is a leak in my bathroom sink and I need help buying plumbing supplies.”

With continued reference to FIGS. 2-3, classifying module 224 includes a set of programming instructions in adaptive query-staff matching program 220, to classify the customer query into one or more predefined categories (step 304). The set of programming instructions is executable by a processor.

In exemplary embodiments, classifying module 224 may categorize a customer query based on its content and urgency. Models trained on a dataset of categorized customer queries classify the query into predefined categories (e.g., product inquiries, service requests, etc.).

In further exemplary embodiments, classifying module 224 perform an urgency assessment and prioritization of customer queries. For example, classifying module 224 evaluates the urgency of each customer query using criteria such as language cues (e.g., “urgent”, “immediately”, “important”) and customer profile data (e.g., VIP customers) and then prioritizes the customer queries to ensure timely response to critical requests.

In alternative embodiments, classifying module 224 employs supervised learning algorithms, such as random forest or support vector machines, for query categorization.

In alternative embodiments, classifying module 224 sends the categorized customer queries to the comparing module 226 to match the customer’s needs with the most helpful staff member for that query.

With continued reference to the illustrative example above, Customer A’s request is prioritized as urgent and is classified as a “plumbing issue” related to “bathroom repair”.

With continued reference to FIGS. 2-3, comparing module 226 includes a set of programming instructions in adaptive query-staff matching program 220, to compare information in the customer query with a staff profile database of the one or more staff members (step 306). The set of programming instructions is executable by a processor.

In exemplary embodiments, comparing module 226 matches customer queries with staff members based on both the nature of the query and the current location of staff and customers within a predefined area (e.g., physical retail store, service environment, etc.). This includes processing customer inquiries through natural language interpretation and aligning them with staff profiles, thus ensuring that the staff member with the most relevant expertise and immediate availability is identified and directed to the customer.

In exemplary embodiments, comparing module 226 receives feedback from customers and staff to not only match queries to staff expertise but also learns and adapts over time, improving its accuracy and efficiency with each interaction.

With continued reference to the illustrative example above, comparing module 226 searches the staff profile database 252 for a matching staff member who is within a proximity of Customer A, has the specific “bathroom plumbing” expertise and is available at the current moment to assist.

With continued reference to FIGS. 2-3, ranking module 228 includes a set of programming instructions in adaptive query-staff matching program 220, to rank the one or more staff members to assist the customer based on the comparison (step 308). The set of programming instructions is executable by a processor.

In exemplary embodiments, ranking module 238 considers the one or more staff members available to assist the customer is further based on analyzing historical interaction data, customer feedback, and staff feedback.

In alternative embodiments, ranking module 238 further considers an urgency level associated with the customer query, an availability of the one or more staff members, and a proximity between the customer and the one or more staff members within the physical retail space.

In further exemplary embodiments, ranking module 238 collects and analyzes interaction feedback data from both the customer and the one or more staff members and incorporates the interaction feedback data to optimize location tracking accuracy and responsiveness. Furthermore, ranking module 238 refines and improves a matching accuracy between the customer and the one or more staff members based on the interaction feedback data.

In exemplary embodiments, ranking module 238 updates the one or more staff member profiles based on recent customer interactions, ongoing training, and availability changes. Ranking module 238 further updates an expertise ranking of the one or more staff members based on historical interaction data, performance reviews, and customer feedback.

In further exemplary embodiments, ranking module 238 adjusts, dynamically, staff availability status in real-time, considering breaks, meetings, and other non-availability periods.

Further, ranking module 238 integrates the updated one or more staff member profiles and availability status to provide for an accurate staff-customer pairing.

With continued reference to the illustrative example above, ranking module 238 provides a short list of three staff members within the proximity of Customer A. Staff member A is taking a break in five minutes. Staff member B has the plumbing knowledge, however, has recently received poor customer interaction feedback. Staff member C is finishing up helping another customer, is in the aisle next to Customer A, has the requisite plumbing knowledge, and has received exceptional customer service interaction feedback recently. Ranking module 238 ranks the three staff members in the following order to assist Customer A: (1) Staff member C; (2) Staff member B; (3) Staff member A.

With continued reference to FIGS. 2-3, directing module 229 includes a set of programming instructions in adaptive query-staff matching program 220, to direct the highest-ranking staff member to assist the customer (step 310). The set of programming instructions is executable by a processor.

In exemplary embodiments, directing module 229 may send an alert, or notification, to a staff member’s computing device (e.g., computing device 230) directing the staff member to the customer’s exact location and providing a short synopsis of the customer’s query.

In alternative embodiments, directing module 229 may notify the customer that a staff member is finishing up with another customer and will arrive shortly to their location to assist with the query.

With continued reference to the illustrative example above, Staff member C is quickly connected to Customer A to assist. As such, Customer A is a satisfied customer. Customer A received a knowledgeable plumbing specialist who properly guided the purchase of the right products and offered invaluable advice on the plumbing leak repair process. Based on the experience, Customer A provides feedback to adaptive query-staff matching program 220, thus updating Staff member C’s staff profile.

An alternative illustrative example includes Customer A shopping in an electronics store looking to buy a new laptop but is overwhelmed by the variety of options and technical applications. Adaptive query-staff matching program 220 identifies and alerts a staff member specializing in computers who then assists the customer in choosing a laptop that fits their needs and budget, thus enhancing the customer’s decision-making process and satisfaction.

Another alternative illustrative example includes Customer A in a high-end fashion boutique, where the customers seek personalized advice and insights into the latest trends and fitting. Adaptive query-staff matching program 220 enables the boutique to match customers with fashion advisors who possess the right expertise, thus elevating the shopping experience and potentially increasing sales through personalized service.

Adaptive query-staff matching program 220 improves customer experience in retail services by quickly connecting customers with the right staff members to improve satisfaction and loyalty, a key metric for retail business success.

Furthermore, adaptive query-staff matching program 220 provides valuable data on staff performance and customer interactions, thus helping businesses optimize their workforce deployment and training, thus aligning with a business’ focus on data-driven decision-making.

In exemplary embodiments, network 202 is a communication channel capable of transferring data between connected devices and may be a telecommunications network used to facilitate telephone calls between two or more parties comprising a landline network, a wireless network, a closed network, a satellite network, or any combination thereof. In another embodiment, network 202 may be the Internet, representing a worldwide collection of networks and gateways to support communications between devices connected to the Internet. In this other embodiment, network 202 may include, for example, wired, wireless, or fiber optic connections which may be implemented as an intranet network, a local area network (LAN), a wide area network (WAN), or any combination thereof. In further embodiments, network 202 may be a Bluetooth network, a WiFi network, or a combination thereof. In general, network 202 can be any combination of connections and protocols that will support communications between host server 210, computing device 230, RTLS 240, and database server 250.

What is claimed is:

1. A computer-implemented method for matching a customer with a staff member,
comprising:
receiving a customer query from a customer located within a physical retail space;
classifying the customer query into one or more predefined categories;
comparing information in the customer query with a staff profile database of the one or more staff members;
ranking the one or more staff members to assist the customer based on the comparison; and
directing a highest-ranking staff member to assist the customer.

2. The computer-implemented method of claim 1, wherein ranking the one or more staff members to assist the customer is further based on an urgency level associated with the customer query, an availability of the one or more staff members, and a proximity between the customer and the one or more staff members within the physical retail space.

3. The computer-implemented method of claim 1, wherein ranking the one or more staff members available to assist the customer is further based on analyzing historical interaction data, customer feedback, and staff feedback.

4. The computer-implemented method of claim 1, further comprising:
continuously updating, in real-time, the information included in the staff profile database, wherein the information comprises a respective staff member’s area of expertise, professional qualifications, historical performance metrics, and real-time availability.

5. The computer-implemented method of claim 1, further comprising:
tracking movement and location of both the customer and the one or more staff members in real-time;
analyzing a proximity of the customer and the one or more staff members;
identifying when the customer query matches a nearby staff member’s expertise; and
facilitating a swift physical connection by triggering an alert to notify both the customer and the one or more staff members.

6. The computer-implemented method of claim 1, further comprising:
collecting and analyzing interaction feedback data from both the customer and the one or more staff members;
incorporating the interaction feedback data to optimize location tracking accuracy and responsiveness; and
refining and improving a matching accuracy between the customer and the one or more staff members based on the interaction feedback data.

7. The computer-implemented method of claim 1, further comprising:
updating the one or more staff member profiles based on recent customer interactions, ongoing training, and availability changes;
updating an expertise ranking of the one or more staff members based on historical interaction data, performance reviews, and customer feedback;
adjusting, dynamically, staff availability status in real-time, considering breaks, meetings, and other non-availability periods; and
integrating the updated one or more staff member profiles and availability status to provide for an accurate staff-customer pairing.

8. A computer program product comprising one or more computer-readable storage media and program instructions stored on the one or more storage media to perform operations comprising:
receiving a customer query from a customer located within a physical retail space;
classifying the customer query into one or more predefined categories;
comparing information in the customer query with a staff profile database of the one or more staff members;
ranking the one or more staff members to assist the customer based on the comparison; and
directing a highest-ranking staff member to assist the customer.

9. The computer program product of claim 8, wherein ranking the one or more staff members to assist the customer is further based on an urgency level associated with the customer query, an availability of the one or more staff members, and a proximity between the customer and the one or more staff members within the physical retail space.

10. The computer program product of claim 8, wherein ranking the one or more staff members available to assist the customer is further based on analyzing historical interaction data, customer feedback, and staff feedback.

11. The computer program product of claim 8, further comprising:
continuously updating, in real-time, the information included in the staff profile database, wherein the information comprises a respective staff member’s area of expertise, professional qualifications, historical performance metrics, and real-time availability.

12. The computer program product of claim 8, further comprising:
tracking movement and location of both the customer and the one or more staff members in real-time;
analyzing a proximity of the customer and the one or more staff members;
identifying when the customer query matches a nearby staff member’s expertise; and
facilitating a swift physical connection by triggering an alert to notify both the customer and the one or more staff members.

13. The computer program product of claim 8, further comprising:
collecting and analyzing interaction feedback data from both the customer and the one or more staff members;
incorporating the interaction feedback data to optimize location tracking accuracy and responsiveness; and
refining and improving a matching accuracy between the customer and the one or more staff members based on the interaction feedback data.

14. The computer program product of claim 8, further comprising:
updating the one or more staff member profiles based on recent customer interactions, ongoing training, and availability changes;
updating an expertise ranking of the one or more staff members based on historical interaction data, performance reviews, and customer feedback;
adjusting, dynamically, staff availability status in real-time, considering breaks, meetings, and other non-availability periods; and
integrating the updated one or more staff member profiles and availability status to provide for an accurate staff-customer pairing.

15. A computer system comprising:
a processor set;
one or more computer-readable storage media; and
program instructions stored on the one or more storage media to cause the processor set to perform operations comprising:
receiving a customer query from a customer located within a physical retail space;
classifying the customer query into one or more predefined categories;
comparing information in the customer query with a staff profile database of the one or more staff members;
ranking the one or more staff members to assist the customer based on the comparison; and
directing a highest-ranking staff member to assist the customer.

16. The computer system of claim 15, wherein ranking the one or more staff members to assist the customer is further based on an urgency level associated with the customer query, an availability of the one or more staff members, and a proximity between the customer and the one or more staff members within the physical retail space.

17. The computer system of claim 15, wherein ranking the one or more staff members available to assist the customer is further based on analyzing historical interaction data, customer feedback, and staff feedback.

18. The computer system of claim 15, further comprising:
continuously updating, in real-time, the information included in the staff profile database, wherein the information comprises a respective staff member’s area of expertise, professional qualifications, historical performance metrics, and real-time availability.

19. The computer system of claim 15, further comprising:
tracking movement and location of both the customer and the one or more staff members in real-time;
analyzing a proximity of the customer and the one or more staff members;
identifying when the customer query matches a nearby staff member’s expertise; and
facilitating a swift physical connection by triggering an alert to notify both the customer and the one or more staff members.

20. The computer system of claim 15, further comprising:
collecting and analyzing interaction feedback data from both the customer and the one or more staff members;
incorporating the interaction feedback data to optimize location tracking accuracy and responsiveness; and
refining and improving a matching accuracy between the customer and the one or more staff members based on the interaction feedback data.
